(19) United States
(12) Patent Application Publication
(10) Pub. No.: US 2015/0357919 A1
(43) Pub. Date: Dec. 10, 2015

(54) METHOD AND SYSTEM FOR VARIABLE OUTPUT POWER SUPPLY

(71) Applicant: Avogy, Inc., San Jose, CA (US)

(72) Inventors: Antoin Russell, Berkley, CA (US); Alberto Doronzo, San Jose, CA (US); Saeed Alipour, Laguna Niguel, CA (US)

(21) Appl. No.: 14/301,046

(22) Filed: Jun. 10, 2014

(51) Int. Cl. H02M 3/335

(52) U.S. Cl. CPC H02M 3/33507

(57) ABSTRACT

A variable output power supply includes a power unit comprising a housing including an output port and a controller disposed in the housing and in communication with the output port. The variable output power supply also includes a power cable. The controller is operable to modify operation of the output port in response, at least in part, to insertion of the power cable in the output port.

### BACKGROUND OF THE INVENTION

Mobile electronic devices, such as portable computers, tablets, smart phones, electronic book readers, and the like, are becoming increasingly popular. These mobile devices are typically powered by batteries. Power adapters (e.g., alternating current (AC) power adapters) are typically provided in conjunction with mobile electronic devices so that the mobile devices can be powered by or recharged using an electrical outlet.

Despite the progress made in power adapters for mobile devices, there is a need in the art for improved methods and systems related to power supplies.

### SUMMARY OF THE INVENTION

The present invention relates generally to electronic devices. Embodiments of the present invention provide variable output voltage power supplies. More particularly, embodiments of the present invention include a power supply that modifies the output voltage as a result of the power cable connected to the power supply. The present invention has wider applicability beyond power supplies to include other electronic devices.

According to an embodiment of the present invention, a variable output power supply is provided. The variable output power supply includes a power unit comprising a housing including an output port and a controller disposed in the housing and in communication with the output port. The variable output power supply also includes a power cable. The controller is operable to modify operation of the output port in response, at least in part, to insertion of the power cable in the output port.

According to another embodiment of the present invention, a variable output power supply is provided. The variable output power supply includes a power unit comprising a housing including a plurality of output ports and control circuitry disposed in the housing and connected to one of the plurality of output ports. The variable output power supply also includes a power cable. The controller is operable to modify operation of the at least one of the one or more output ports in response to insertion of the power cable in the one of the plurality of output ports.

According to a specific embodiment of the present invention, a method of operating a variable output power supply is provided. The method includes setting an output voltage of an output of the variable output power supply to a default voltage and determining a configuration of an output cable. The method also includes correlating the configuration of the output cable with a predetermined output voltage and modifying the output voltage of the output of the variable output power supply.

Numerous benefits are achieved by way of the present invention over conventional techniques. For example, embodiments of the present invention provide a power supply that operates at multiple output voltages, increasing the number of different devices that can be powered using the power supply. These and other embodiments of the present invention, along with many of its advantages and features, are described in more detail in conjunction with the text below and attached figures.

### BRIEF DESCRIPTION OF THE DRAWINGS

FIG. 1A is perspective diagram of a power unit of a variable output power supply and a power cable according to an embodiment of the present invention.

FIG. 1B is a perspective view of a power cable connected to a power unit of a variable output power supply according to an embodiment of the present invention.

FIG. 1C is a perspective view of a power cable unable to connect to a power unit of a variable output power supply according to an embodiment of the present invention.

FIG. 1D is a perspective view of a single output power unit according to an embodiment of the present invention.

FIG. 2 is a drawing illustrating a keyed power cable according to an embodiment of the present invention.

FIG. 3A is a simplified schematic diagram of the power unit of the variable output power supply according to an embodiment of the present invention.

FIG. 3B is a simplified schematic diagram of the power unit of the variable output power supply according to a particular embodiment of the present invention.

FIG. 3C is a simplified schematic diagram of a single output implementation of the power unit of the variable output power supply according to an embodiment of the present invention.

FIG. 3D is a simplified schematic diagram of another single output implementation of the power unit of the variable output power supply according to an embodiment of the present invention.

FIG. 3E is a simplified schematic diagram of yet another single output implementation of the power unit of the variable output power supply according to an embodiment of the present invention.

FIG. 3F is a simplified schematic diagram of a dual output implementation of the power unit of the variable output power supply according to an embodiment of the present invention.

FIG. 3G is a simplified schematic diagram of another dual output implementation of the power unit of the variable output power supply according to an embodiment of the present invention.

FIG. 4 is a schematic diagram illustrating a pin configuration for a power cable according to an embodiment of the present invention.

FIG. 5 is a simplified flowchart illustrating a method of operating the variable output power supply according to an embodiment of the present invention.

### DETAILED DESCRIPTION OF SPECIFIC EMBODIMENTS

The present invention relates generally to electronic devices. More specifically, the present invention relates to a power supply that is operable to output different voltages (and/or wattage) in response to the type of power cable that is connected to the output connector of the power supply. In a particular embodiment, an output connector that initially operates as a standard 5 V USB output connector is modified to operate at 19.5 V in response to a special cable being connected to the output connector.

According to an embodiment of the present invention, a power supply is provided that includes a port with a keyed opening (i.e., a keyhole) that is operable to receive a power cable with a matching key. When the power cable is connected to the port, the power supply detects the configuration of the power cable and adjusts the output of the port accordingly. Thus, the voltage of the power supply is a function of or is dependent on the configuration of the power cable.

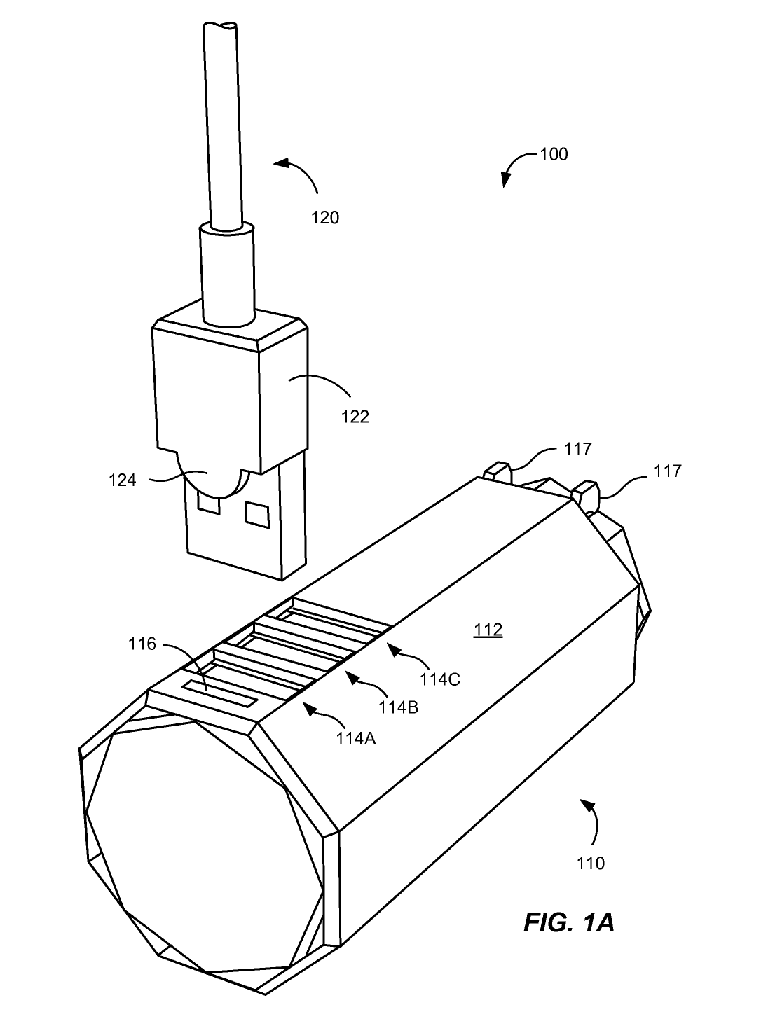

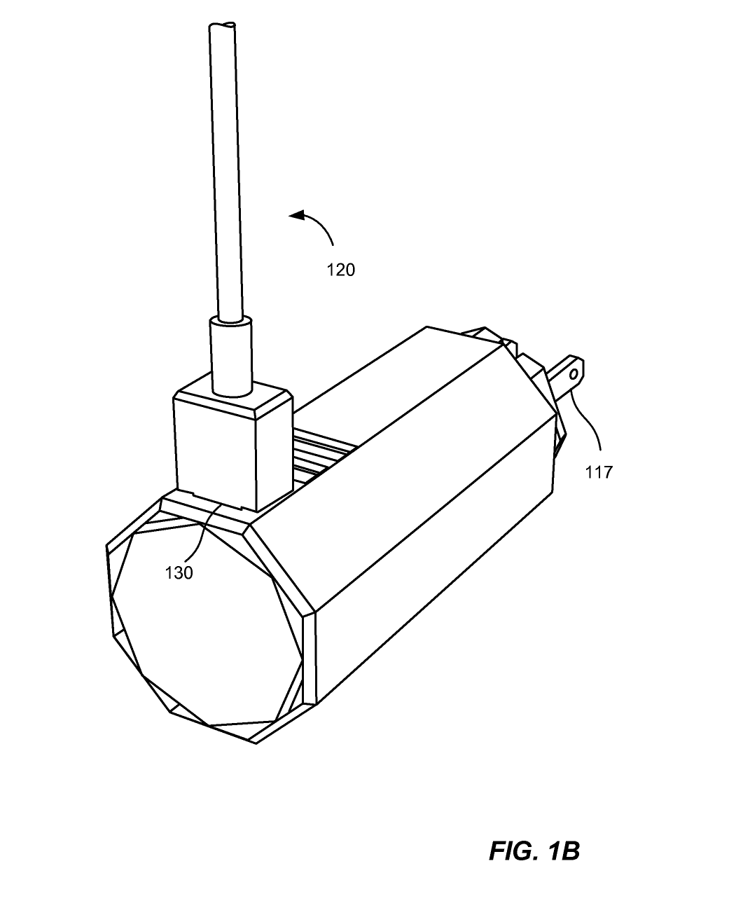

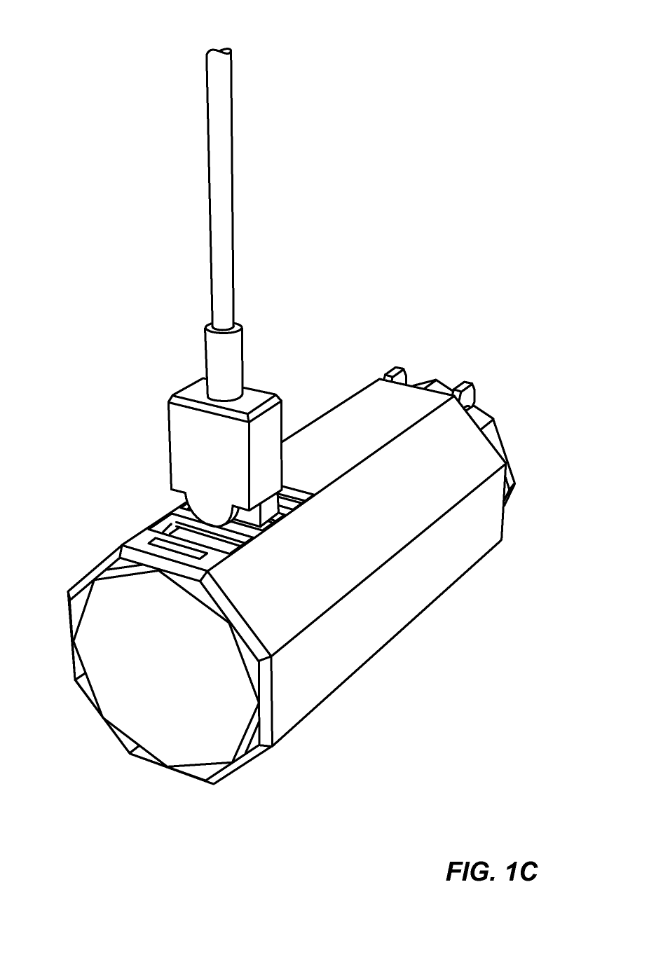

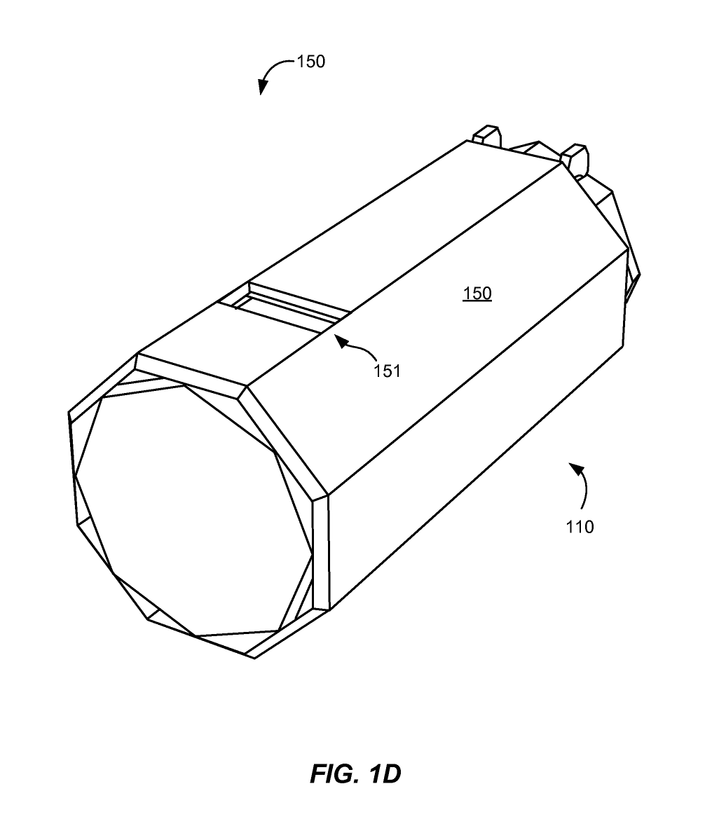

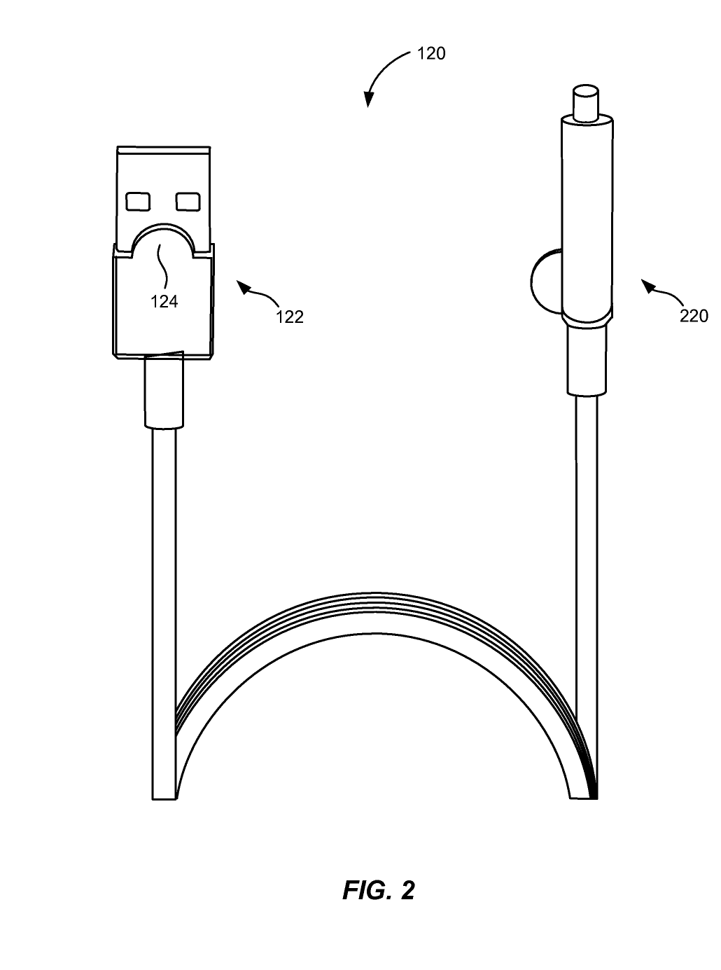

FIG. 1A is perspective diagram of a variable output power supply and a power cable according to an embodiment of the present invention. As illustrated in FIG. 1A, the variable output power supply 100 includes a power unit 110 and a power cable 120. Additional description related to power cable 120 is illustrated in FIG. 2. The power unit 110 includes a housing 112 and a plurality of output ports 114A, 114B, and 114C, also referred to as output connections. In the illustrated embodiment, there are three output ports, but this is not required by embodiments of the present invention and other number of output ports, including one, two, four, five, six, or more, are included within the scope of the present invention.

As described more fully herein, the plurality of output ports 114A, 114B, and 114C differ, with one or more of the output ports providing a variable voltage output depending on the type of power cable connected to the output connection. In some embodiments, one of the plurality of output ports, for example, output port 114A is operable to output multiple voltages depending on the configuration or type of the power cable and is thus referred to as a variable voltage output port. As an example, the output port 114A can operate as a standard 5 V compliant USB port when a standard USB cable is connected. However, when a special cable is connected, the operation of the output port 114A is modified to operate at a higher voltage (e.g., 19.5 V), which is suitable for charging a portable computer. Thus, the output port 114A is variable depending on the cable that is connected, providing functionality not available using conventional designs.

Others of the plurality of output connections, for example, output ports 114B and 114C do not modify their operation in response to the cable that is connected. In one implementation, output ports 114B and 114C are standard 5 V USB ports that can be used to charge mobile phones, tablets, or the like. Thus, standard USB cables can be plugged into ports 114B and 114C and will operate as a standard USB cable, for example, at 5 V output.

It should be noted that in some embodiments, the output ports 114A, 114B/114C are modified USB ports and standard USB ports, respectively. However, this is not required by the present invention and other connector designs can be utilized including standardized and proprietary connector designs, including plugs, receptacles, and terminal blocks. One of ordinary skill in the art would recognize many variations, modifications, and alternatives.

Referring to FIG. 1A, the power cable 120 has a modified USB connector 122 that includes a key 124 that extends a predetermined distance toward the end of the modified USB connector 122. As illustrated in FIG. 1A, the key 124 is disposed on the exterior surface of the power cable, although other keying arrangements are included within the scope of the present invention. Port 114A on the power unit includes a matched opening 116 to receive the key 124. The key 124 prevents the power cable 120 from being inserted into a standard USB connector as illustrated in FIG. 1C, in which insertion of the modified USB connector 122 into port 114B is prevented by the key 124 butting against the housing 112. It should be noted that ports 114B and 114C lack opening 116 adjacent to their port, thereby preventing power cable 120 from being inserted into either of ports 114B and 114C. As illustrated in FIG. 1B, once the power cable 120 is inserted into port 114A, the key (not shown) is positioned in the matched opening, the edge of which is illustrated by line 130

It should be noted that in FIGS. 1A-1C, only a single variable output port is illustrated, but embodiments of the present invention are not limited to a single variable output port. In other embodiments, multiple variable output ports are provided, each including a key, which can be identical or different depending on the application. Thus, in one implementation, a first power cable having a first key could be connected to a first variable output port and utilized to charge a laptop computer. A second power cable having a second key could be connected to a second variable output port and utilized to charge a different voltage laptop computer or another electronic device that is charged at a different voltage than a laptop computer. Although some embodiments of the present invention work in conjunction with keyed output cables, this is not required by the present invention. Rather, some embodiments provide a variable voltage output at one or more of the output ports without the use of a key and keyhole. In some implementations, the key on the output cable prevent misidentification of parts by a user and does not provide an electrical function.

Referring to FIG. 1A, the power unit includes port 114A, which is a variable voltage port and ports 114B and 114C, which are standard USB ports. Thus, in comparison with multiple output USB devices, embodiments of the present invention provide different voltage outputs from different ports. Although multiple ports 114A, 114B, and 114C are illustrated in FIG. 1A, it should be noted that a single variable output port could be provided in some implementations, with the voltage of the port varying depending on the power cable that is utilized in conjunction with the power unit. Thus, a single port embodiment of the power supply is included with the scope of the present invention providing a power adapter that can output multiple voltage levels depending on configuration.

FIG. 1D is a perspective view of a single output power unit according to an embodiment of the present invention. As illustrated in FIG. 1D, the power unit 150 includes a single variable output power port 151. Similar to port 114A, port 151 is able to provide two or more output voltages as a function of the power cable that is connected to the port. In an embodiment, port 151 is able to output 5V when a standard USB cable is connected and 19.5V when a special (e.g., high voltage) power cable is connected. Although 19.5V is utilized to represent a conventional laptop computer charging voltage, the present invention is not limited to this particular voltage and other voltages including 12V, 14V, 16.5V, 18V, 20V, and 21V, as well as voltage ranges around these values, for example, 19.0V-19.9V as a range around 19.5V are included within the scope of the present invention. In other embodiments, the port is able to output additional voltages or a range of voltages as described herein. In the implementation illustrated in FIG. 1D, no matched opening operable to receive a key is provided. Thus, some embodiments of the present invention do not require the keying function described herein.

FIG. 2 is a drawing illustrating a keyed power cable according to an embodiment of the present invention. As illustrated in FIG. 2, the power cable 120 includes a modified USB connector 122 on the end of the power cable that plugs into the power unit 110 and a standardized laptop computer connector 220 on the other end of the power cable. The power cable is suitable for charging high power devices such as laptop computers. Although the power cable shares some similarities with standard USB cables, the key 124 present on the modified USB connector 122 prevents the power cable 120 from being inserted into a standard USB connector as illustrated in FIG. 1C. As discussed above, the key 124 is not required by the present invention.

Embodiments of the present invention are compliant with a variety of USB standards including USB 2.0 and USB 3.0, USB 3.1, or the like. As described herein, the functionality of the system does not rely on USB compliant cables, but USB cables are illustrated for the purpose of explaining operation of the system. One of ordinary skill in the art would recognize many variations, modifications, and alternatives.

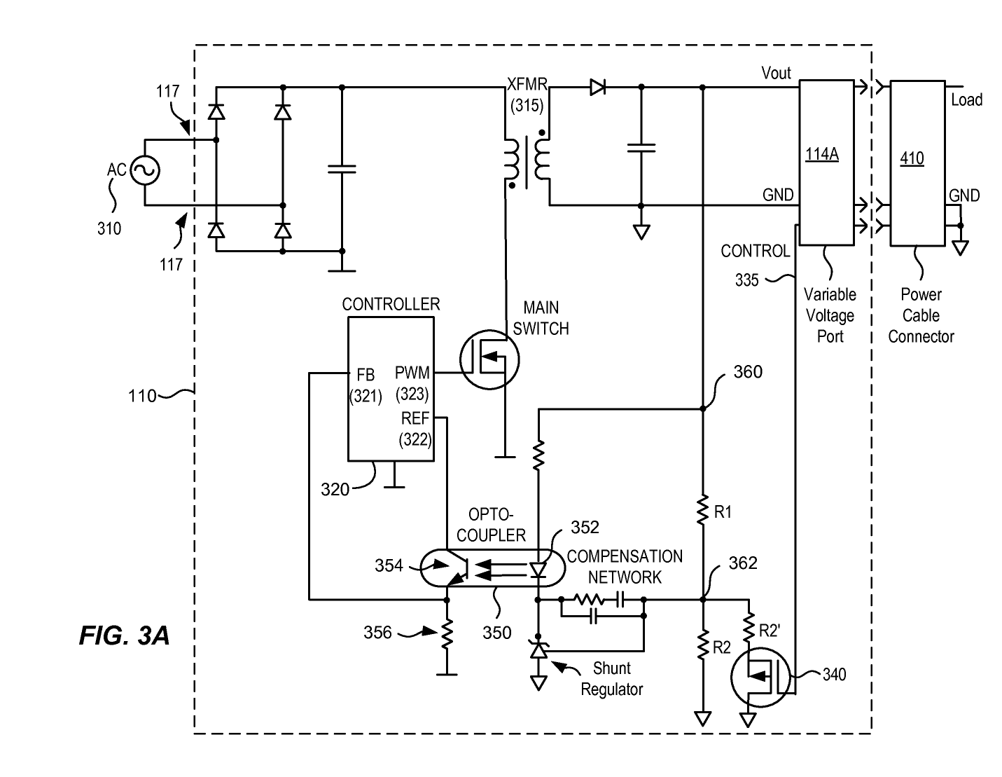

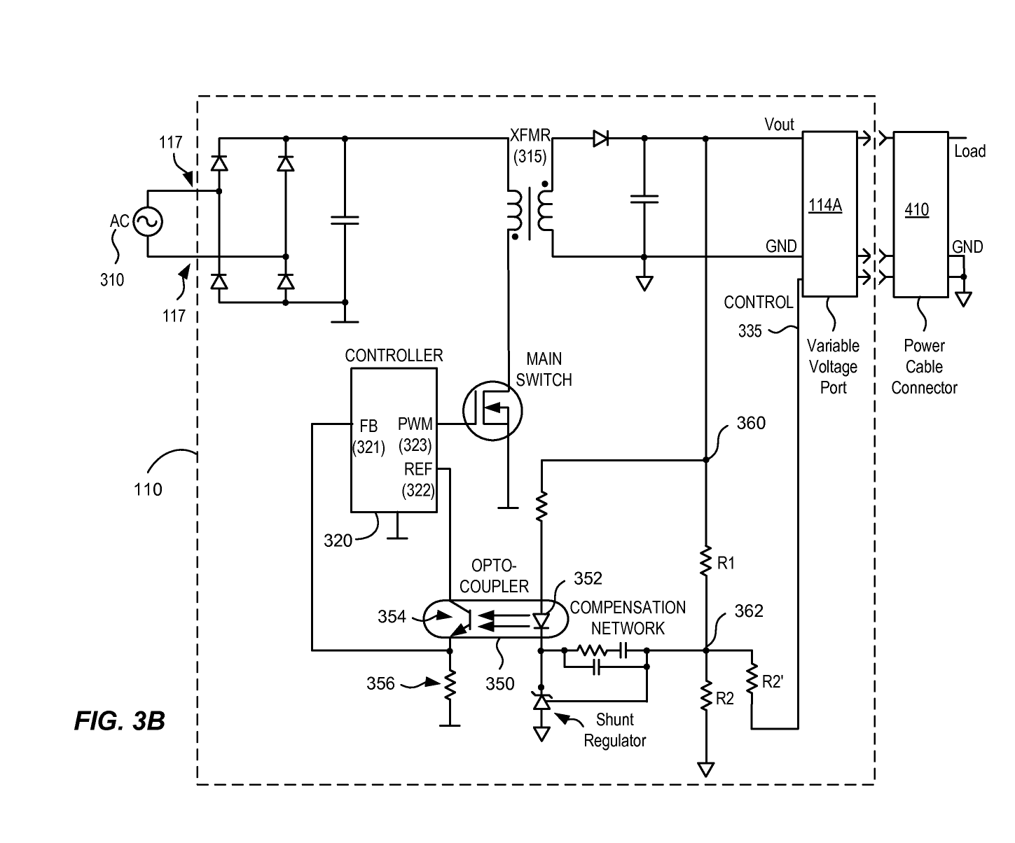

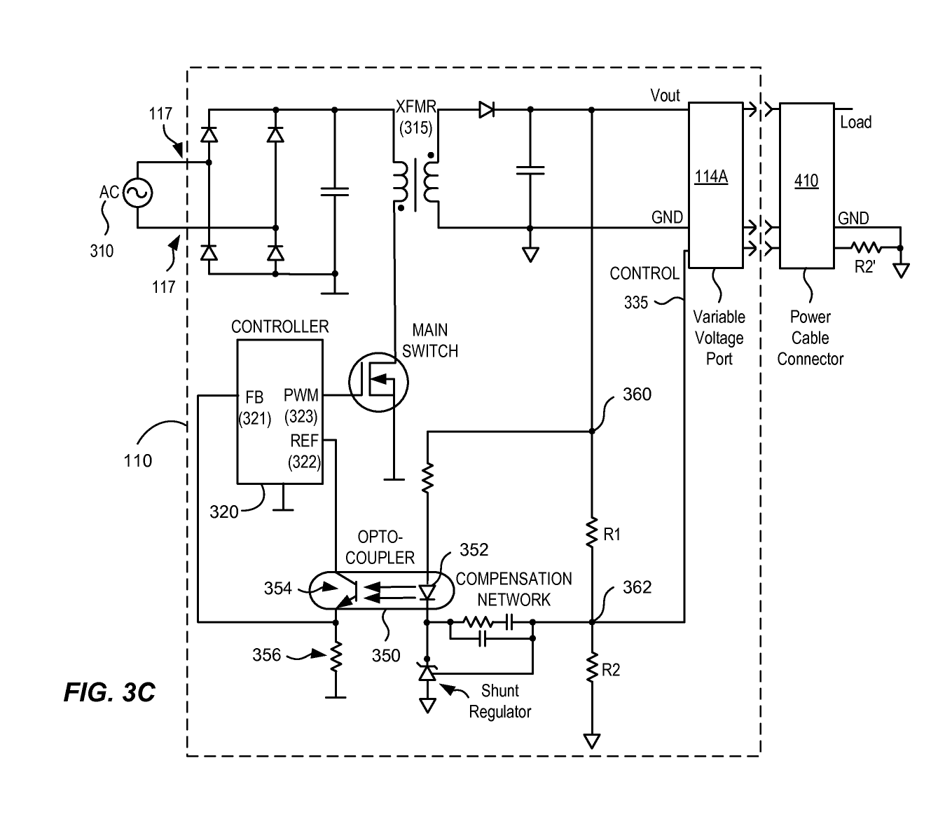

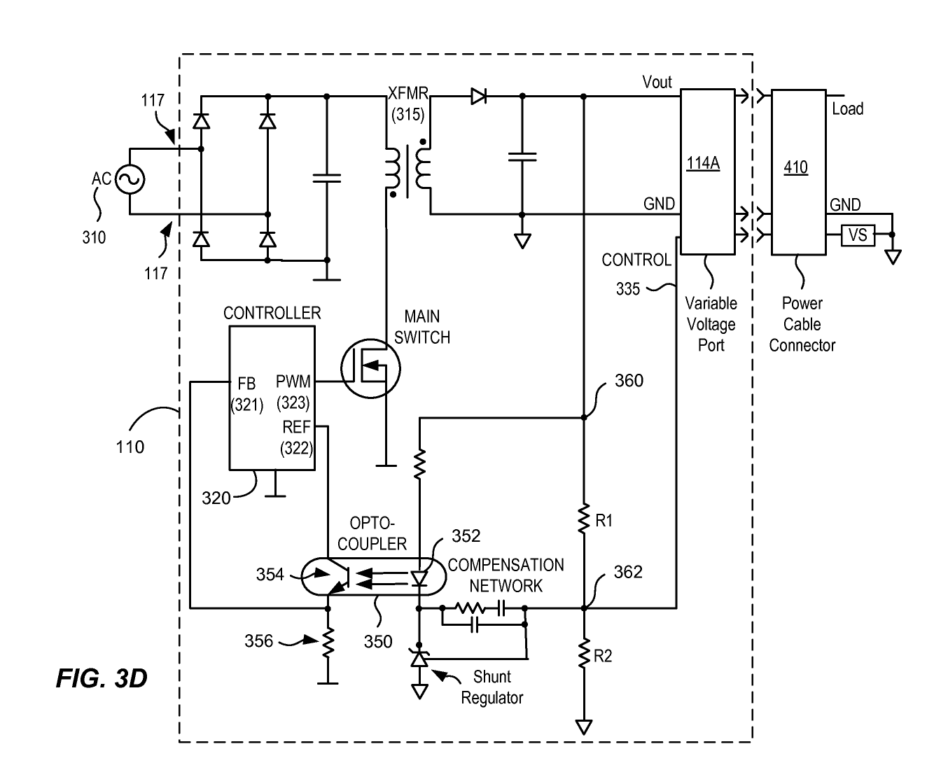

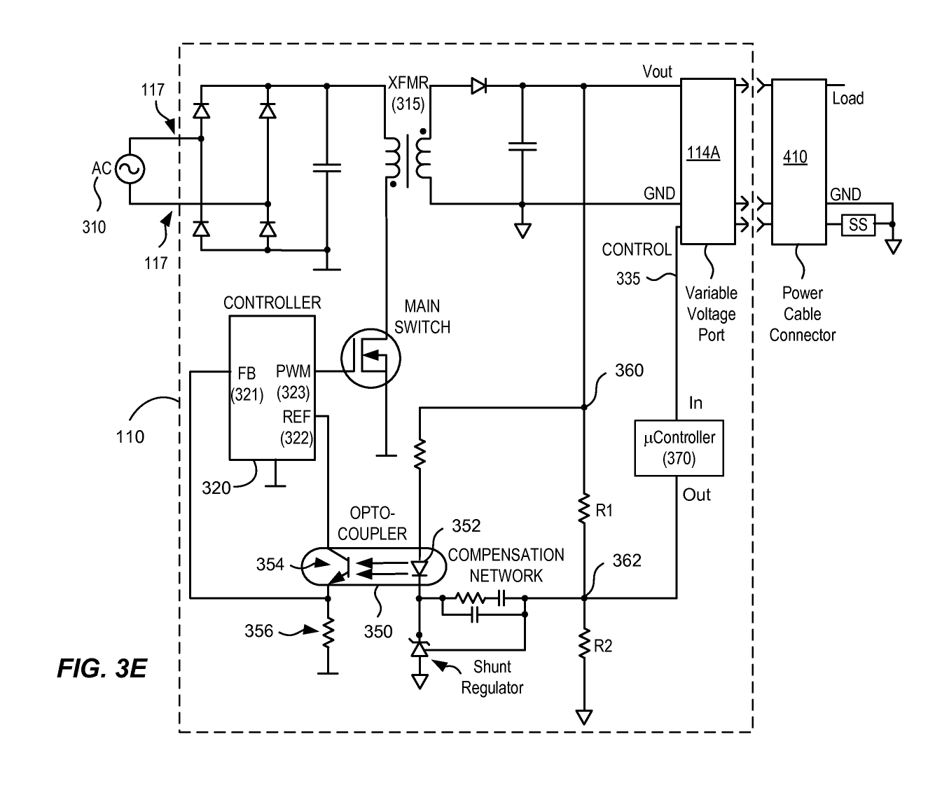

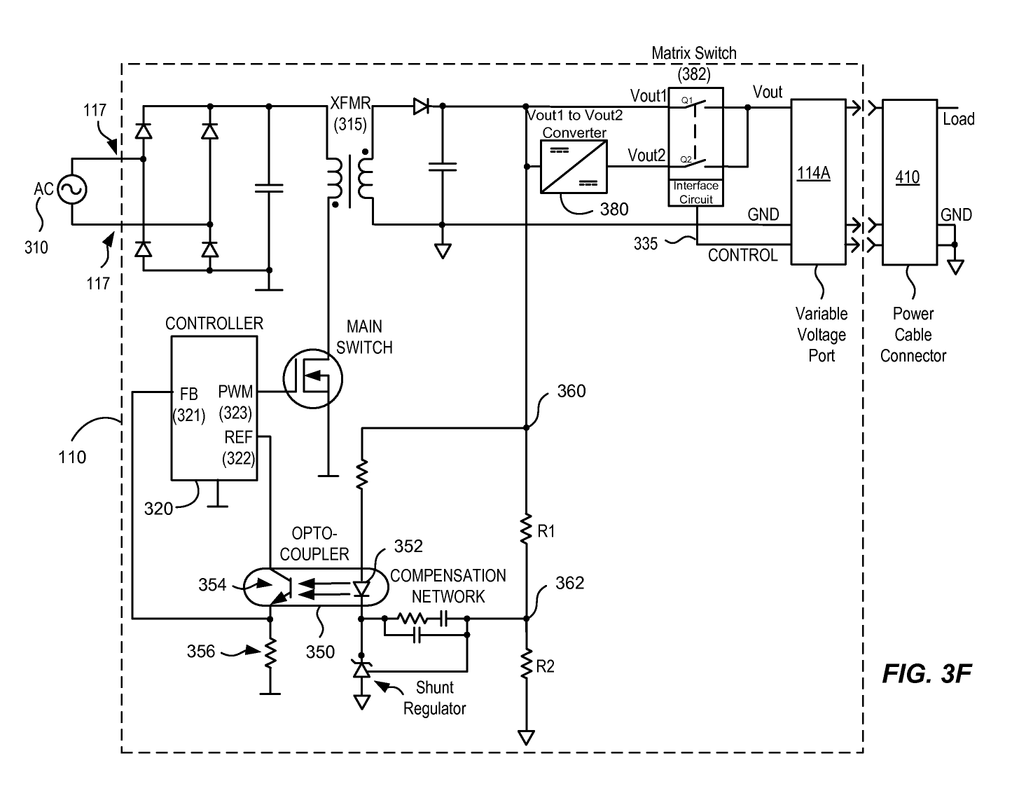

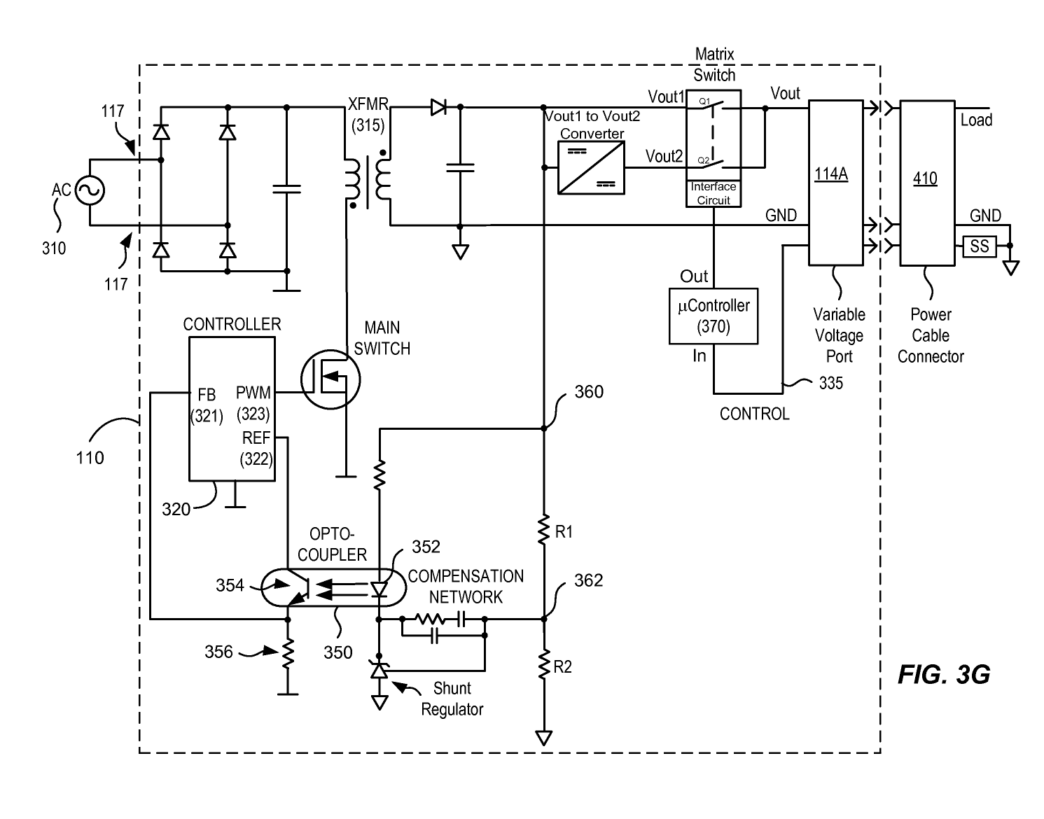

FIG. 3A is a simplified schematic diagram of the power unit of the variable output power supply according to an embodiment of the present invention. The power unit (illustrated by reference number 110 in FIG. 1A) includes an electrical connection to an external power supply 310. In the embodiment illustrated in FIG. 1A, a set of extendable prongs 117 are utilized to connect the power unit to an AC voltage source such as a wall socket. In FIG. 1A, the set of prongs are illustrated in the collapsed position and in FIG. 1B, the set of prongs are illustrated in the extended position. The power unit includes a transformer 315 that connects two halves of the power unit. A controller 320 includes a feedback input 321, a reference output 322, and a pulse width modulation (PWM) output 323.

The power unit includes variable voltage port 114A. Electrical connections in the variable voltage output port 114A include Vout, ground, and a control connector. When a power cable having a first type of connector (e.g., a standard connector) is connected to the variable voltage output port 114A, the control line 335 is either floating or at a predetermined voltage and the control FET 340 is in the off state. An example of operation in this state would be when a standard USB connector is inserted into the variable voltage output port. In this case, the control line is floating, the control FET 340 is off, no current flows through R2′ and the voltage Vout and the current through the photodiode 352 in optocoupler 350 is determined by the values of resistors R1 and R2. In some implementations, the current transfer ratio of the optocoupler is unity such that if 1 mA is flowing through the photodiode 352, then 1 mA is generated at the phototransistor 354. The current through the phototransistor 354 and the feedback resistor 356 connected to the emitter of the phototransistor 354 determine the voltage that is used as an input to the feedback input 321 of the controller 320. A precision shunt regulator, which is connected to the compensation network controls voltage on the cathode of the photodiode 352.

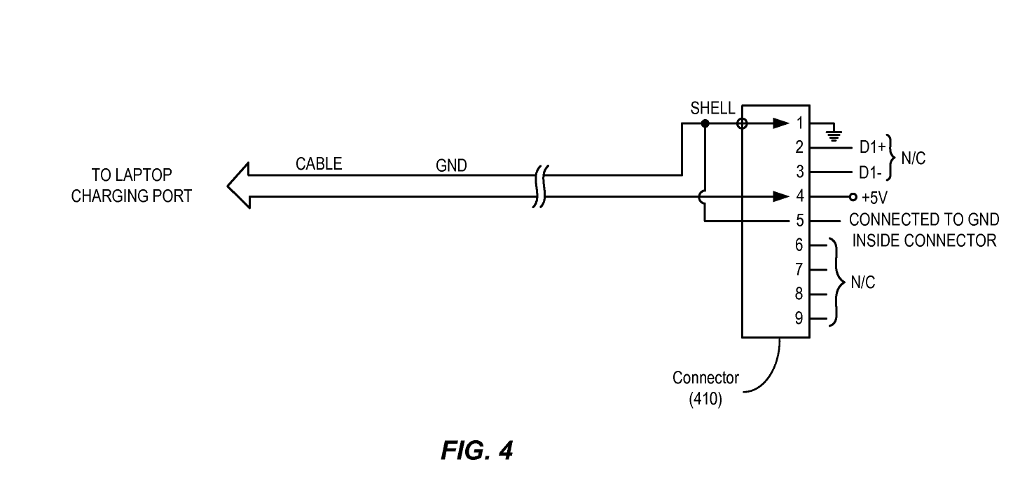

When a power cable with a second connector (e.g., a modified connector) is inserted into the variable voltage output port 114A, then the control line 335 is grounded as a result of the design of the connector (discussed in additional detail in relation to FIG. 4). The grounding of the control line 335 results in the control FET 340 turning on and connecting R2′ to ground. In this configuration, the voltage at node 362 is a function of R2 and R2′ connected in parallel. This modification in voltage resulting from the connection of R2′ in parallel with R2 produces a change in the voltage applied to the cathode of the photodiode 352 and the current in phototransistor 354. The resulting change in the current through and voltage across the feedback resistor 356 results in the controller detecting a change in the voltage at the feedback input 321. The PWM controller 320 then adjusts the PWM output 323 accordingly to modify the output voltage at Vout. Thus, the power unit is able to detect connection of a power cable used for high power operation and modify the voltage of the variable power output port 114A in response to the connection of the special power cable as described throughout the present specification.

In FIG. 3A, the controller 320 is an element of control circuitry, including control line 335, that is connected through control line 335 to the output port that includes the variable output capability. In some sense, the controller 320 and other elements of the control circuitry, which can include microcontroller 370 as illustrated in FIG. 3E, are connected to the variable voltage output port through control line 335. Direct connection is not required since the various components of the control circuitry, including control line 335, resistor R1, resistor R2, resistor R2′, transistor 340, the compensation network, the shunt regulator, the opto-coupler 350, and the main switch, serve specific functions in enabling the variable voltage port to vary the output voltage Vout in response to the connection of the power cable 410 to the variable voltage port 114A.

Although the embodiment illustrated in FIG. 3A utilizes grounding of the control line 335 as a result of grounding of one of the pins inside the power cable, other designs that provide an indication that a special, high power cable has been connected are included within the scope of the present invention. As an example, another implementation utilizes a matrix switch design in which each voltage rail is routed to the output via a switch. When the special power cable is connected, one of the switches is turned on, thereby changing the output voltage. In another alternative implementation, a microcontroller is used that reads the configuration of the cable and changes the output voltage accordingly (e.g., via a digital to analog converter). This alternative implementation enables different voltages to be provided in conjunction with different power cables.

Referring to FIGS. 1A, 1B, and 3A, the variable output power supply includes a power unit 110 that comprises a set of prongs 117 operable to plug into a power outlet 310. The power unit includes a housing 112 that includes a plurality of output ports 114A, 114B, and 114C. The power unit also includes a keyhole 116 disposed in the housing adjacent one of the plurality of output ports (variable output port 114A). The power unit also includes control circuitry disposed in the housing, illustrated in FIG. 3A, and connected to the one of the plurality of output ports. A power cable is used in conjunction with the power unit and includes a key 124 that is operable to be inserted into the keyhole. When the power cable is inserted into the variable output port 114A, the control circuitry is operable to modify operation of the at least the variable output port 114A, for example, increasing the output voltage of the variable output port. In some embodiments, the modification in operation is referred to as being performed in response to insertion of the power cable in the variable output port although other conditions can be applied prior to modification. In some embodiments, insertion is sufficient to provide configuration information on the power cable that is used by the control circuitry to modify the operation.

FIG. 3B is a simplified schematic diagram of the power unit of the variable output power supply according to a particular embodiment of the present invention. As illustrated in FIG. 3B, resistor R2′ is connected to the control line 355. In some implementations, the resistor R2′ can be integrated into the connector of the variable voltage port 114A. When the power cable connector 410 is connected to the variable voltage port 114A, the grounding of the pin to which the control line is thus connected will ground the control line 335, placing R2′ in parallel with R2 and, thereby, changing the voltage at node 362 as discussed in relation to FIG. 3A.

It should be noted that although some embodiments are described in terms of a dual voltage output (i.e., 5V or 19.5V), the present invention is not limited to these voltages. In some embodiments, three or more voltages are provided as appropriate to the particular voltage suitable for device charging. In other embodiments, an output voltage that is continuously variable or variable in increments is provided as described in relation to FIG. 3D, in which the voltage source can be a continuously variable source or a source that varies incrementally, for example, as different resistors are utilized in different output cables.

FIG. 3C is a simplified schematic diagram of a single output implementation of the power unit of the variable output power supply according to an embodiment of the present invention. In the embodiment illustrated in FIG. 3C, resistor R2′ has been integrated into the power cable connector 410. When the power cable connector 410 is connected to the variable voltage port 114A, the control line 335 is connected to ground through resistor R2′, placing R2′ in parallel with R2 and, thereby, changing the voltage at node 362 as discussed in relation to FIG. 3A.

FIG. 3D is a simplified schematic diagram of another single output implementation of the power unit of the variable output power supply according to an embodiment of the present invention. In the embodiment illustrated in FIG. 3D, a voltage source (VS) is connected between a pin of the power cable connector 410 and ground. The connection of the power cable connector 410 to the variable voltage port 114A results in the voltage source VS being connected between node 362 and ground, which modifies the voltage at node 362 and, as a result, the voltage at node 360 as discussed in relation to FIG. 3A. In one implementation, the voltage source is a voltage divider between the bus voltage and the ground. Accordingly, the voltage source VS provides a voltage level to the control line 335 that is then present at node 362. Thus, some embodiments include a voltage source inside the power cable that provides a predetermined voltage to the control line of the power supply. As an example, the resistors selected for the voltage source can result in a voltage at node 362 that will result in two different voltages being produced by the variable voltage port 114A.

In one particular implementation, multiple output cables are provided, each with a unique voltage source VS. In this particular implementation, an arbitrary number of voltages can be provided, for example, a 5 V output for a 5 V cable, a 12 V output for a 12 V cable, a 19.5 V output for a 19.5 volt cable, and the like. In each cable, the appropriate voltage source will be provided to produce the desired voltage at the output.

FIG. 3E is a simplified schematic diagram of yet another single output implementation of the power unit of the variable output power supply according to an embodiment of the present invention. In the embodiment illustrated in FIG. 3E, a signal source (SS) is connected between a pin of the power cable connector 410 and ground. The connection of the power cable connector 410 to the variable voltage port 114A results in the signal source SS being connected between the input of microcontroller 370 and ground. The signal source provides a voltage or current to controller line 335 that is received as an input to the microcontroller (μController) 370. The microcontroller receives the input voltage/current and outputs a voltage that is received at node 362.

The microcontroller can map the inputs (or a range of inputs) to a set of outputs, removing, in the case of a voltage source connected to control line 335, the proportionality between the input voltage on control line 335 and the voltage at node 362. For example, a 1 kΩ resistor in the SS would map to a 5 V Vout, a 2 kΩ resistor in the SS would map to a 12 V Vout, and a 3 kΩ resistor in the SS would map to a 19.5 V Vout, removing the linearity between resistor value and output voltage Vout as the microcontroller distinguishes between different resistors, as well as providing predetermined output voltages when resistors vary from the desired value (e.g., a range of resistors having values from 900Ω to 1.1 kΩ could be understood as a 1 kΩ resistor). Benefits provided by the system illustrated in FIG. 3E include the ability to use commonly available resistors (with limited accuracy) since the resistor value does not directly determine the voltage at node 362, which is determined by the output of the microcontroller 370. Thus, embodiments illustrated in FIG. 3E utilize the microcontroller 370 to provide a single output at node 362 that absorbs variance in the value of the input voltage received by the microcontroller (e.g., the value of a resistor in the voltage source).

FIG. 3F is a simplified schematic diagram of a dual output implementation of the power unit of the variable output power supply according to an embodiment of the present invention. As illustrated in FIG. 3F, a voltage converter 380 is operable to convert voltages from a first voltage (e.g., Vout1) to a second voltage (e.g., Vout2). A first input of matrix switch 382 is connected to node 360. The input to the voltage converter is connected to node 360 and the output of the voltage converter is connected to a second input of matrix switch 382. The matrix switch 382 includes an interface circuit connected to the control line of the variable voltage port 114A.

Initially, the matrix switch 382 is operated in a state that produces an output voltage Vout equal to either Vout1 or Vout2, typically Vout1. When the power cable connector 410 is connected to the variable voltage port 114A, the control line is connected to ground, thereby grounding the input to the interface circuit. The grounding of the interface circuit causes the matrix switch to switch the output at Vout from one voltage to another (e.g., Vout1 to Vout2), or vice versa depending on the particular implementation. Thus, in a manner similar to other embodiments, the power unit senses the configuration of the power cable and adjusts the output voltage accordingly. In this embodiment, the output voltage is switched between two voltage outputs in response to the connection and disconnection of the power cable connector to the variable voltage port.

FIG. 3G is a simplified schematic diagram of another dual output implementation of the power unit of the variable output power supply according to an embodiment of the present invention. In the embodiment illustrated in FIG. 3G, a signal source (SS) is connected between a pin of the power cable connector 410 and ground. The connection of the power cable connector 410 to the variable voltage port 114A results in the signal source SS being connected between the input of microcontroller 370 and ground. The control line 335 provides an input to the microcontroller 370, which provides, as an output, an input to the interface circuit of the matrix switch. As described in relation to FIG. 3F, the interface circuit causes the matrix switch to switch the output at Vout from one voltage to another (e.g., Vout1 to Vout2), or vice versa depending on the particular implementation. The combination of the signal source and the microcontroller provides an alternative to the grounded control line illustrated in FIG. 3F in a manner similar to the combination of the signal source and microcontroller illustrated in FIG. 3E provided an alternative to the voltage source illustrated in FIG. 3D. One of ordinary skill in the art would recognize many variations, modifications, and alternatives.

FIG. 4 is a schematic diagram illustrating a pin configuration for a power cable according to an embodiment of the present invention. As illustrated in FIG. 4, the power cable includes a number of pins 1-9 disposed in a connector 410. In an embodiment, the connector 410 is a USB compliant connector that provides additional functionality. In an embodiment, Pin 1 of the connector is grounded to the shell of the connector. The USB communication interface (D1+ and D1−) is provided on Pins 2 and 3 and 5V is output on Pin 4, which are unchanged from a standard USB cable.

Pin 5 is connected to ground, for example, by grounding (e.g. inside the connector) to the shell to which Pin 1 is grounded. In operation, when the connector is connected to the variable power output port of the power unit, the grounding of Pin 5 is sensed by the power unit 110, which modifies the output voltages on Pin 4 in response to the connection of the illustrated power cable. In this embodiment, no change is made to Pins 6-9. The end of the power cable opposing connector 410 provides a computer connector that is suitable for charging of different computers, including laptop computers and other mobile or battery powered computers. Since different computers utilize different power connectors, the charging connection will be modified depending on the particular application. One of ordinary skill in the art would recognize many variations, modifications, and alternatives.

As described in relation to FIG. 3A, the grounding of Pin 5 modifies the voltage at a node of the voltage divider, enabling a controller in the power unit to increase the output voltage (e.g., 19.5 V) that is provided to Pin 4. Although Pin 5 is utilized in this exemplary embodiment to provide information to the power unit related to the voltage rating of the power cable, other suitable pins can be utilized according to embodiments of the present invention.

Thus, using embodiments of the present invention, the power unit is able to modify the output voltage (thus, the reference to a variable output power supply) depending on the type of power cable that is connected to the power unit. In the embodiment illustrated in FIG. 4, when a standard USB (e.g., USB 3.0) cable is connected, then Pin 4 outputs +5 V. On the other hand, when the power cable with Pin 5 grounded is connected to the power unit, the output of Pin 4 is changed to +19.5 V, which is compatible with laptop computer charging. As will be evident to one of skill in the art, the particular voltages (e.g., +5 V and +19.5 V) are utilized merely by way of example and the present invention is not limited to these particular voltage values. In other embodiments, the performance of the variable output power supply is measured in terms of power (wattage).

Although some embodiments of the present invention are discussed in relation to laptop computer charging, embodiments of the present invention are not limited to this particular application and other specialized power cables can be implemented for various non-standard charging applications. As an example, a power cable for a tablet, camera, PDA, navigation device, gaming consoles, camcorders, headphones, or the like could have a pin other than Pin 5 grounded, indicating operation at the appropriate predetermined charging voltage. In response to one of these power cables being plugged into the power unit, the power unit would modify the output voltage to the appropriate voltage for the particular device. One of ordinary skill in the art would recognize many variations, modifications, and alternatives.

Thus, the power cable in this embodiment is configured such that insertion into the output port of the power unit results in modification of the operating state of the output port. In some implementations, the connector 410 is a modified USB connector that includes a key that prevents the power cable from being inserted into a standard USB port as illustrated in FIG. 1C. Although the power cable illustrated in FIG. 4 shares some similarities with conventional USB cables, the power cable is able to operate at higher voltages than conventional USB cables, enabling the power cable to provide a laptop computer charging functionality.

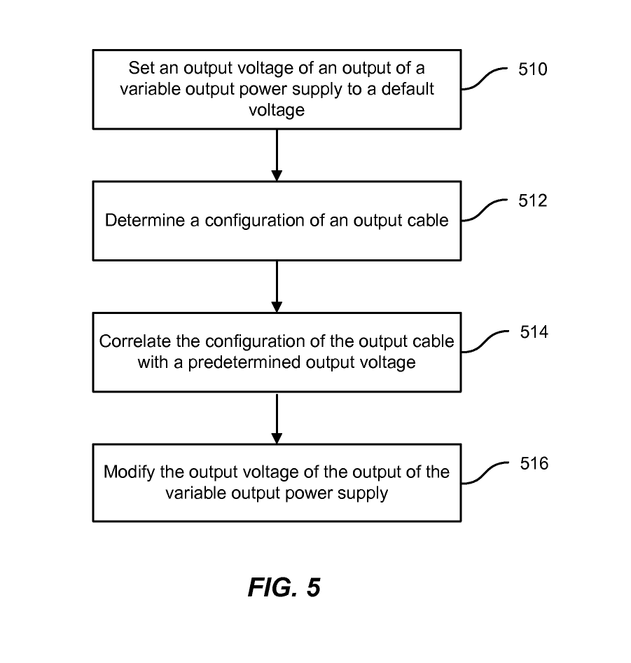

FIG. 5 is a simplified flowchart illustrating a method of operating the variable output power supply according to an embodiment of the present invention. The method includes setting an output voltage of an output of the variable output power supply to a default voltage (510). In an embodiment, the default voltage is 5V, which is the voltage associated with an output cable that is compliant with the USB standard. Thus, conventional cables, including USB-compliant cables can be utilized with the variable output power supply described herein.

The method also includes determining a configuration of an output cable (512) and correlating the configuration of the output cable with a predetermined output voltage (e.g., 19.5 V) (514). Determining the configuration can be done by measuring a voltage or current associated with a pin of the output cable, which can be a power cable for a laptop computer or other suitable electronic device. When the output cable is connected to an output port of the variable output power supply, the pins of the output cable are connected to the pins of the output port, enabling voltages and currents present on the pins of the output cable to be measured, including a determination that one of the pins of the output cable is grounded. Based on the configuration of the output cable, the correlation between the configuration and the desired output voltage of the power supply can be established.

As an example, the grounding of one of the pins of the output cable as illustrated in FIG. 3A results in resistor R2′ being placed in parallel with resistor R2, thereby changing the voltage at node 362. In this case, the configuration of the output cable (i.e., grounding of the pin connected to control line 335) is correlated with an increase in Vout to the predetermined voltage. In some cases, for example, as illustrated in FIG. 3C, the value of resistor R2′ in the output cable connector results in a direct correlation between the configuration of the output cable and the predetermined output voltage, whereas in other embodiments, as described below in relation to FIG. 3E, the correlation is not direct, but can be mapped in a non-linear or other manner. As another example, in FIG. 3E, the configuration of the output cable results in the connection of the signal source SS to the control line 335. The microcontroller determines that for this configuration of the output cable, the presence of and value associated with the signal source indicates the correlation between the configuration of the output cable (i.e., value of the signal source signal) and the voltage Vout that is provided by the variable voltage port 114A. As described in relation to FIG. 3E, different signal source signals (e.g., the current associated with a 1 kΩ resistor vs. a 2 kΩ resistor) are correlated with different output voltage (e.g., Vout=5 V vs. Vout=19.5 V). Thus, in this example, different configurations of the output cable are correlated with different output voltages.

The method further includes modifying (e.g., increasing) the output voltage of the output of the variable output power supply (516). As examples, the output voltage can be increased from 5 V to 19.5 V. In some embodiments, the method includes detecting connection of the power cable to the output of the variable output power supply.

It should be appreciated that the specific steps illustrated in FIG. 5 provide a particular method of operating a variable output power supply according to an embodiment of the present invention. Other sequences of steps may also be performed according to alternative embodiments. For example, alternative embodiments of the present invention may perform the steps outlined above in a different order. Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize many variations, modifications, and alternatives.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A variable output power supply comprising:
a power unit comprising:
a housing including an output port; and
a controller disposed in the housing and in communication with the output port; and
a power cable, wherein the controller is operable to modify operation of the output port in response, at least in part, to insertion of the power cable in the output port.

2. The variable output power supply of claim 1 further comprising a set of prongs operable to plug the power unit into a power outlet.

3. The variable output power supply of claim 1 wherein the output port complies with a USB standard.

4. The variable output power supply of claim 1 wherein the controller comprises a voltage divider operable to modify a pulse width modulation format of the power unit.

5. The variable output power supply of claim 1 wherein the power cable comprises a predetermined pin that is grounded.

6. The variable output power supply of claim 1 wherein the power cable comprises at least one of a voltage source or a signal source.

7. The variable output power supply of claim 1 wherein insertion of the power cable in the output port is operable to modify an output voltage of the output port.

8. The variable output power supply of claim 1 further comprising a keyhole adjacent the output port, wherein the power cable comprises a key operable to be inserted into the keyhole.

9. A variable output power supply comprising:
a power unit comprising:
a housing including a plurality of output ports; and
control circuitry disposed in the housing and connected to one of the plurality of output ports; and
a power cable, wherein the controller is operable to modify operation of the at least one of the one or more output ports in response to insertion of the power cable in the one of the plurality of output ports.

10. The variable output power supply of claim 9 wherein the power unit further comprises a set of prongs operable to plug into a power outlet.

11. The variable output power supply of claim 9 wherein the power unit further comprises a keyhole disposed in the housing adjacent to the one of the plurality of output ports and wherein the power cable further comprises a key operable to be inserted into the keyhole.

12. The variable output power supply of claim 9 wherein modifying the operation of the one of the plurality of output connections comprises increasing a voltage rating of the one of the plurality of output connections.

13. The variable output power supply of claim 9 wherein modifying the operation of the one of the plurality of output connections comprises decreasing a voltage rating of the one of the plurality of output connections.

14. The variable output power supply of claim 9 wherein a first of the plurality of output connections is rated at a first voltage and a second of the plurality of output connections is rated at a second voltage different from the first voltage.

15. The variable output power supply of claim 9 wherein one or more of the plurality of output ports comprise USB ports.

16. The variable output power supply of claim 9 wherein the controller comprises a sensor operable to detect connection of the power cable.

17. The variable output power supply of claim 9 wherein one or more pins of the power cable are grounded to indicate a configuration of the power cable.

18. The variable output power supply of claim 9 wherein the key is disposed on an exterior surface of the power cable.

19. A method of operating a variable output power supply, the method comprising:
setting an output voltage of an output of the variable output power supply to a default voltage;
determining a configuration of an output cable;
correlating the configuration of the output cable with a predetermined output voltage; and
modifying the output voltage of the output of the variable output power supply.

20. The method of claim 19 further comprising detecting connection of the power cable to the output of the variable output power supply.

21. The method of claim 19 wherein modifying the output voltage comprises increasing the output voltage.

22. The method of claim 21 wherein increasing the output voltage comprises increasing the output voltage from 5 V to 19.5 V.

23. The method of claim 19 wherein modifying the output voltage comprises decreasing the output voltage.

24. The method of claim 19 wherein the default voltage is 5V.

25. The method of claim 19 wherein the default voltage is compliant with the USB standard.

26. The method of claim 19 wherein the predetermined voltage is 19.5 V.

27. The method of claim 19 wherein the configuration of the output cable comprises a connector having a predetermined pin connected to ground.

28. The method of claim 19 wherein correlating the configuration of the output cable comprises receiving a voltage or a current at a microcontroller of the variable output power supply.
